(19) United States
(12) Patent Application Publication
(10) Pub. No.: US 2022/0207367 A1
(43) Pub. Date: Jun. 30, 2022

(54) Method and Device for Classifying Data

(71) Applicant: Hyperconnect, Inc., Seoul (KR)

(72) Inventors: Sang Il Ahn, Seoul (KR); Youngkyu Hong, Seoul (KR); Seungju Han, Seoul (KR); Kwanghee Choi, Seoul (KR); Seokjun Seo, Seoul (KR); Beomsu Kim, Seoul (KR); Buru Chang, Seoul (KR)

(73) Assignee: Hyperconnect, Inc., Seoul (KR)

(21) Appl. No.: 17/646,465

(22) Filed: Dec. 29, 2021

(30) Foreign Application Priority Data
Dec. 29, 2020 (KR) 10-2020-0185909
Nov. 26, 2021 (KR) 10-2021-0165109

(51) Int. Cl. G06N 3/08; G06F 16/28

(52) U.S. Cl. CPC G06N 3/08; G06F 16/285

(57) ABSTRACT

A method of classifying data includes: training a classification model for classifying input data into at least one class, such that a first output value is generated according to a second equation in which a component corresponding to a label distribution of source data is disentangled in a first equation corresponding to the classification model; generating a second output value by applying, to the first output value, information indicating a label distribution of target data; and classifying the target data into the at least one class by using the second output value.

### CROSS-REFERENCE TO RELATED APPLICATION

This application is based on and claims priority under 35 U.S.C. § 119 to Korean Patent Application No. 10-2020-0185909, filed on Dec. 29, 2020, and Korean Patent Application No. 10-2021-0165109, filed on Nov. 26, 2021, in the Korean Intellectual Property Office, the disclosures of which are herein incorporated by reference in their entireties.

### BACKGROUND

### 1. Field

One or more embodiments relate to a method and a device for classifying data.

### 2. Description of the Related Art

Recently, techniques for classifying input data into predefined classes in combination with deep learning technology have been developed. Classification models (or classifiers) determine the class to which input data belongs, and, even when the input data does not belong to any predefined classes, classify the input data as the most similar class among the predefined classes. Therefore, the accuracy of a classification model is considered as an important factor to ensure the integrity of a service.

Meanwhile, when a classification model is generated by using deep learning technology, the accuracy of the classification model depends on the distribution of the training data. Accordingly, there is an increasing demand for a technique for generating an accurate classification model regardless of the distribution of training data.

### SUMMARY

One or more embodiments include a method and a device for classifying data.

One or more embodiments include a computer-readable recording medium having recorded thereon a program for executing the method in a computer. The technical objects of the disclosure are not limited to the technical objects described above, and other technical objects may be inferred from the following embodiments.

Additional aspects will be set forth in part in the description which follows and, in part, will be apparent from the description, or may be learned by practice of the presented embodiments of the disclosure.

According to an aspect of the disclosure, a method of classifying data includes: training a classification model for classifying input data into at least one class, such that a first output value is generated according to a second equation in which a component corresponding to a label distribution of source data is disentangled in a first equation corresponding to the classification model; generating a second output value by applying, to the first output value, information indicating a label distribution of target data; and classifying the target data into the at least one class by using the second output value.

According to another aspect of the disclosure, a computer-readable recording medium includes a recording medium having recorded thereon a program for executing the method described above on a computer.

According to another aspect of the disclosure, a device for classifying data includes: a memory storing at least one program; and a processor configured to execute the at least one program to train a classification model for classifying input data into at least one class, such that a first output value is generated according to a second equation in which a component corresponding to a label distribution of source data is disentangled in a first equation corresponding to the classification model, generate a second output value by applying, to the first output value, information indicating a label distribution of target data, and classify the target data into the at least one class by using the second output value.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for describing an example of classification of input data into at least one class;

FIGS. 2A and 2B are diagrams for describing examples of operations of classification models in training phases and inference phases;

FIG. 3 is a diagram for describing an example of a classification result according to a distribution of source data for training;

FIG. 4 is a flowchart illustrating an example of a method of classifying data, according to an embodiment;

FIG. 5 is a configuration diagram illustrating an example of a device for classifying data, according to an embodiment; and

FIG. 6 is a diagram for describing an example in which a second output value is utilized, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Although the terms used in the embodiments are selected from among common terms that are currently widely used, the terms may be different according to an intention of one of ordinary skill in the art, a precedent, or the advent of new technology. Also, in particular cases, the terms are discretionally selected by the applicant of the disclosure, in which case, the meaning of those terms will be described in detail in the corresponding part of the detailed description. Therefore, the terms used in the specification are not merely designations of the terms, but the terms are defined based on the meaning of the terms and content throughout the specification.

Throughout the specification, when a part “includes” an element, it is to be understood that the part may additionally include other elements rather than excluding other elements as long as there is no particular opposing recitation. Also, the terms described in the specification, such as “ . . . er (or)”, “ . . . unit”, “ . . . module”, etc., denote a unit that performs at least one function or operation, which may be implemented as hardware or software or a combination thereof.

In addition, although the terms such as “first” or “second” may be used herein to describe various elements, these elements should not be limited by these terms. These terms are only used to distinguish one element from another element.

Hereinafter, embodiments will be described in detail with reference to the accompanying drawings. The embodiments may, however, be embodied in many different forms and should not be construed as being limited to the embodiments set forth herein.

This application is a continuation of Korean Patent Application No. 10-2020-0185909. Accordingly, the descriptions in this specification is based on those of Korean Patent Application No. 10-2020-0185909. Therefore, the descriptions in Korean Patent Application No. 10-2020-0185909 may be referenced in understanding the inventive concept to be described in this specification, and the descriptions in Korean Patent Application No. 10-2020-0185909, including those omitted herein, may be employed in the inventive concept to be described in this specification.

Hereinafter, embodiments will be described in detail with reference to the drawings.

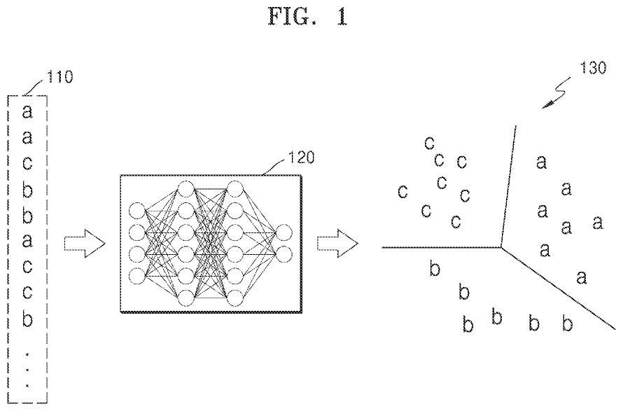

FIG. 1 is a diagram for describing an example of classification of input data into at least one class.

FIG. 1 illustrates an example of input data 110, a classification model 120, and a classification result 130. Although FIG. 1 illustrates that the input data 110 is classified into a total of three classes, the number of classes is not limited to the example of FIG. 1.

There is no limitation on the type of the input data 110. For example, the input data 110 may correspond to various types of data such as (but not limited to) images, texts, and/or audio.

The classification model 120 may classify the input data 110 into specific classes. For example, the classification model 120 may calculate a probability that input data is classified as each class, by using a softmax function and cross-entropy.

For example, assuming that the input data 110 is an image, a first class is ‘Male’, and a second class is ‘Female’, the classification model 120 classifies an input image as the first class or the second class. Even when the input data 110 is an animal image, the classification model 120 can classify the input image as a class that is determined to be more similar among the first class and the second class.

Meanwhile, the classification model 120 may be trained based on training data. In this case, the distribution of the training data may affect the learning of the classification model 120. In other words, the performance of the classification model 120 may depend on the distribution of the training data.

The classification model 120 may be trained such that an error (or loss) between a result output from the classification model 120 and an actual correct answer is reduced. For example, in the case where the training data exhibits a long-tailed distribution (e.g., where some classes have many samples and other classes have very few samples), and cross-entropy based on a softmax function is used for training the classification model 120, the classification model 120 that has been trained may be overfitted to major classes.

In order to solve the overfitting-related issue, methods of, for example, undersampling parts of training data that belong to major classes or oversampling those that belong to minor classes have been typically used. However, such methods assume that training data exhibits a uniform distribution, and in the case where the training data does not actually exhibit a uniform distribution, the learning performance of classification models that have been trained using such methods may degrade.

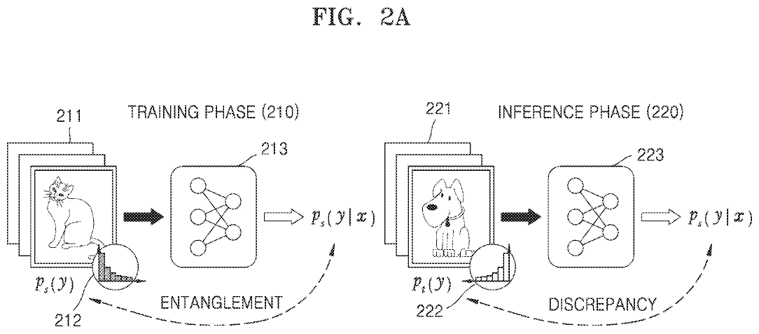

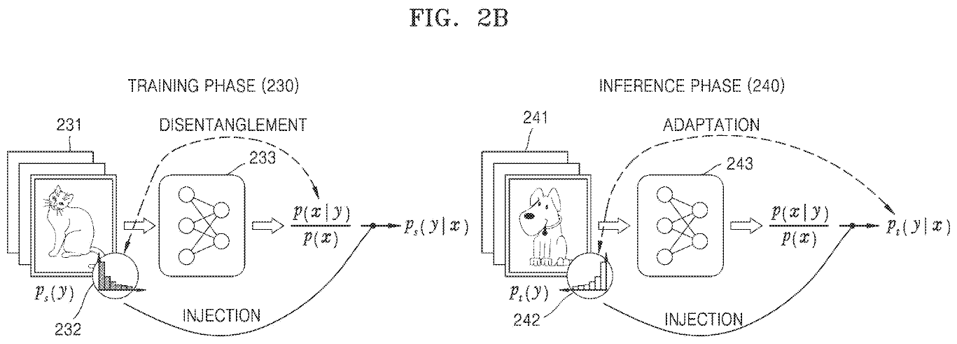

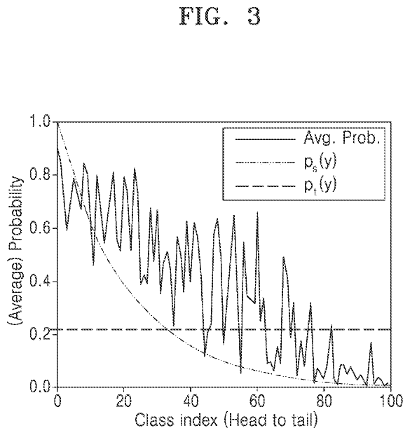

Details on how the distribution of training data affects the learning of the classification model 120 will be described below with reference to FIGS. 2 and 3.

FIGS. 2A and 2B are diagrams for describing examples of operations of classification models 213, 223, 233, and 243 in training phases 210 and 230 and inference phases 220 and 240.

FIG. 2A illustrates an overview of the training phase 210 and the inference phase 220 based on the classification models 213 and 223 according to the related art.

As described above with reference to FIG. 1, a training result (or conditional probability) of the classification model 213 may be strongly influenced by a label distribution 212 of training data 211. In other words, the training result of the classification model 213 may vary depending on the label distribution 212 of the training data 211. The correlation between the label distribution 212 of the training data and the training result of the classification model 213 may be described with Equation 1 below. Here, Equation 1 corresponds to Bayes' rule.

$${p}_{s} ( y \vert x ) = \frac{{p}_{s} ( y ) {p}_{s} ( x \vert y )}{{p}_{s} ( x )} = \frac{{p}_{s} ( y ) {p}_{s} ( x \vert y )}{{\sum }_{c} {p}_{s} ( c ) {p}_{s} ( x \vert c )} \qquad [ Equation 1 ]$$

In Equation 1, pₛ(y|x) denotes the conditional probability of a class (label) y for a given sample x from the training data, and pₛ(y) denotes the probability of class y occurring (i.e., the distribution of class y) in the source training data. Also, in Equation 1, pₛ(x|y) denotes the probability of sample x occurring when class y is given, and pₛ(x) denotes the probability of sample x occurring (i.e., the distribution of training data x) in the source training data. Also, in Equation 1, c is a variable that denotes each of the classes.

Referring to Equation 1, it may be seen that pₛ(y|x), which is the training result of the classification model 213, is correlated to pₛ(y), which is the distribution of class y in the source (or training) data. In other words, it may be seen that the training result of the classification model 120 is entangled with the distribution of class y in the source data. Accordingly, the training result of the classification model 120 depends on the distribution of class y in the training data.

Meanwhile, a label distribution 222 of input data 221 in the inference phase 220 may be different from the label distribution 212 of the training data 211. For example, as illustrated in FIG. 2A, the label distribution 212 of the training data 211 and the label distribution 222 of the input data 221 may not be identical to each other, and even in some cases, the label distribution 212 of the training data 211 and the label distribution 222 of the input data 221 may exhibit opposite trends.

When the label distribution 212 of the training data 211 and the label distribution 222 of the input data 221 are not identical to each other, a classification result of the input data 221 in the inference phase 220 may be inaccurate. As described above with reference to Equation 1, because the label distribution 212 of the training data 211 and the training result pₛ(y|x) are entangled with each other, when the label distribution 222 of the input data 221 and the label distribution 212 of the training data 211 are different from each other, a discrepancy may occur between the label distribution 222 of the input data 221 and the conditional probability of the trained classification model 223. Accordingly, as the discrepancy between the label distribution 212 of the training data 211 and the label distribution 222 of the input data 221 increases, the accuracy of a classification result by the trained classification model 223 may decrease. This can be a major factor that degrades the performance of the trained classification model 223.

FIG. 2B illustrates an overview of the training phase 230 and the inference phase 240 of the classification models 233 and 243 according to an embodiment.

As described above with reference to FIG. 2A, according to the related art, the training result of the classification model 213 is entangled with the label distribution 212 of the training data 211.

Accordingly, in the training phase 230 according to an embodiment, the classification model 233 is trained based on a second equation in which a component corresponding to a label distribution 232 of source data 231 is disentangled from a first equation (e.g., Equation 1) corresponding to the classification model 233, such that the label distribution 232 of the source data 231 does not affect the learning of the classification model 233. In numerous embodiments, classification models can be trained using only the distribution of the samples x (pₛ(x)) from the training data and the conditional distribution of samples x given the labels y (pₛ(x|y)). Then, in the inference phase 240, a component related to a label distribution 242 of target data 241 is applied to the trained classification model 243, and classification of the target data 241 is performed based on the trained classification model 243. Components related to a label distribution in accordance with numerous embodiments of the invention can be determined using various methods, such as (but not limited to) Monte Carlo approximations. Accordingly, regardless of whether the label distribution 232 of the source data 231 and the label distribution 242 of the target data 241 are identical to each other, the target data 241 may be accurately classified.

FIG. 3 is a diagram for describing an example of a classification result according to a distribution of source data for training.

FIG. 3 is a graph showing a correlation between pₛ(y) representing a distribution of class y in the source data, pₜ(y) representing a distribution of class y in target data, and a classification result (represented by Avg. Prob.) of the target data by the trained classification model 223.

Referring to FIG. 3, the classification result (Avg. Prob.) derived from the target data is similar to pₛ(y). This is because learning of the classification model 213 depends on pₛ(y). Therefore, as described above with reference to FIG. 2A, although the classification result of the target data according to the trained classification model 223 should be similar to pₜ(y), the actual classification result (Avg. Prob.) of the target data may be different from pₜ(y).

According to a device for classifying data according to an embodiment, the trained classification model 243 may accurately classify the target data 241 regardless of the distribution 232 of the source data 231. In other words, regardless of whether the distribution 232 of the source data 231 and the distribution 242 of the target data 241 are different from each other, the device for classifying data according to an embodiment may accurately classify the target data 241. In detail, the device for classifying data according to an embodiment may be trained based on a result

$$( \frac{{p}_{s} ( x \vert y )}{{p}_{s} ( x )} )$$

in which pₛ(y) is disentangled from pₛ(y|x) in Equation 1, and may operate to accurately classify the target data 241 by applying, to the training result, information indicating the label distribution of the target data 241.

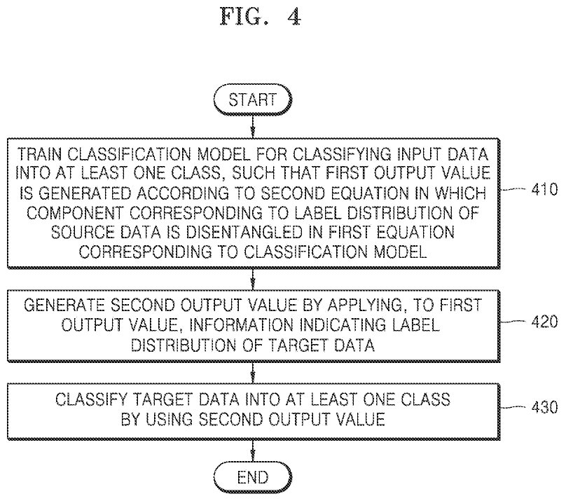

FIG. 4 is a flowchart illustrating an example of a method of classifying data, according to an embodiment.

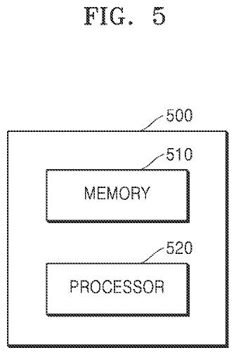

The method of classifying data illustrated in FIG. 4 may be executed by a device for classifying data which will be described below with reference to FIG. 5. In detail, the method of classifying data illustrated in FIG. 4 may be performed by a processor 520 illustrated in FIG. 5. Accordingly, it will be understood by one of skill in the art that the subject to perform operations in the flowchart of FIG. 4 can be the processor 520 of FIG. 5.

In operation 410, the method trains a classification model for classifying input data into at least one class, such that a first output value is generated according to a second equation in which a component corresponding to a label distribution of source data is disentangled in a first equation corresponding to the classification model. In numerous embodiments, classification models can be trained using only the distribution of the samples x (pₛ(x)) from the training data and the conditional distribution of samples x given the labels y (pₛ(x|y)).

Here, the first equation refers to Bayes' rule represented by Equation 1. That is, the first equation represents the probability of input data being classified as each of at least one class. In addition, the component corresponding to the label distribution of the source data may be pₛ(y) of Equation 1.

As described above with reference to FIGS. 2 and 3, according to Equation 1, the label distribution of the source data (i.e., the distribution of at least one class (or label) according to the source data) and the training result of the classification model may be entangled with each other. Accordingly, the method may release the entanglement between the label distribution of the source data and the training result of the classification model by training the classification model based on a result of disentangling the component corresponding to the label distribution of the source data in Equation 1.

In detail, the method may perform the following two operations by using Equation 1. In a first operation, the processor separates pₛ(y) from pₛ(y|x) in Equation 1. In other words, the processor separates pₛ(y) from

$$\frac{{p}_{s} ( y ) {p}_{s} ( x \vert y )}{{p}_{s} ( x )}$$

of Equation 1, which results in a second equation

$$( \frac{{p}_{s} ( x \vert y )}{{p}_{s} ( x )} ) .$$

In a second operation in accordance with some embodiments of the invention, the processor can replace pₛ(y) in pₛ(x) in the second equation

$$( \frac{{p}_{s} ( x \vert y )}{{p}_{s} ( x )} )$$

with the uniform prior pᵤ(y). That is, pᵤ(y=c)=1/C, where C denotes the total number of classes.

Through the two operations, the method may train the classification model based on the second equation such that Equation 2 below is satisfied.

$${f}_{θ} ( x ) [ y ] = log \frac{{p}_{u} ( x \vert y )}{{p}_{u} ( x )} \qquad [ Equation 2 ]$$

In Equation 2, f_{θ}(x)[y] is a first modeling objective for the logits of the classification model. That is, the method trains the classification model based on the second equation

$$( \frac{{p}_{s} ( x \vert y )}{{p}_{s} ( x )} )$$

such that the modelling objective (f_{θ}(x)[y]) is maximized (or minimized). Here, training the classification model based on the second equation

$$( \frac{{p}_{s} ( x \vert y )}{{p}_{s} ( x )} )$$

means causing the classification model to learn to maximize (or minimize)

$$log \frac{{p}_{u} ( x \vert y )}{{p}_{u} ( x )} ,$$

which is a logarithmic term of Equation 2.

For example, the method may train the classification model based on the second equation

$$( \frac{{p}_{s} ( x \vert y )}{{p}_{s} ( x )} )$$

by using at least one approximation formula with respect to the second equation

$$( \frac{{p}_{s} ( x \vert y )}{{p}_{s} ( x )} )$$

and/or information (pₛ(y)) indicating the label distribution of the source data, such that the first output value (f_{θ}(x)[y]) is generated. Here, the at least one approximation formula can include (but is not limited to) a regularized Donsker-Varadhan (DV) representation and/or a Monte Carlo approximation formula.

In detail, the regularized DV representation may be represented by Equation 3 below. The regularized DV representation according to Equation 3 acts to enable the classification model to learn the logarithmic term of Equation 2.

$$log \frac{dℙ}{dℚ} = {}_{T : Ω \to ℝ}^{arg m ax} ( {𝔼}_{ℙ} [ T ] - log ( {𝔼}_{ℚ} [ {e}^{T} ] ) - {λ ( log ( {𝔼}_{ℚ} [ {e}^{T} ] ) )}^{2} ) \qquad [ Equation 3 ]$$

In Equation 3, [symbol] and [symbol] denote arbitrary distributions that satisfy supp( [symbol] )⊆supp( [symbol] ). Also, in Equation 3, it is assumed that, for every function T:Ω→ [symbol] on some domain Ω, the function T that minimizes the regularized DV representation is the log-likelihood ratio of [symbol] and [symbol] . In addition, Equation 3 is satisfied for any λ∈ [symbol] ⁺ when the expectations are finite.

The method in accordance with numerous embodiments of the invention can plug [symbol] =pᵤ(x|y) and [symbol] =pᵤ(x) into Equation 3, and choose the function family of T:Ω→ [symbol] to be parameterized by the logits of a deep neural network. Accordingly, f_{θ}(x)[y] of Equation 2 may approach the target objective of Equation 3. In other words, the processor may train the classification model to learn

$$log \frac{{p}_{u} ( x \vert y )}{{p}_{u} ( x )}$$

(i.e., the optimal f_{θ}(x)[y]), which is the logarithmic term of Equation 2, by using Equation 4 below. For example, the method may train the classification model until the left-hand side and the right-hand side of Equation 4 are equal to each other.

$$log \frac{ {p}_{u} ( x \vert y )}{{p}_{u} ( x )} \geq {}_{{f}_{θ}}^{arg ma x} ( {𝔼}_{x \sim {p}_{u} ( x \vert y )} [ {f}_{θ} ( x ) [ y ] ] - log {𝔼}_{x \sim {p}_{u} ( x )} [ {e}^{{f}_{θ} ( x ) [ y ]} ] - {λ ( log {𝔼}_{x \sim {p}_{u} ( x )} [ {e}^{{f}_{θ} ( x ) [ y ]} ] )}^{2} ) \qquad [ Equation 4 ]$$

Meanwhile, it is difficult to exactly estimate the expectation of pᵤ(x|y) and pᵤ(x) through Equation 4. Accordingly, the method may train the classification model by plugging a Monte Carlo approximation formula into Equation 4. An example of a Monte Carlo approximation formula is shown in Equations 5 and 6 below.

$$\begin{matrix} {𝔼}_{x \sim {p}_{u} ( x \vert c )} [ {f}_{θ} ( x ) [ c ] ] \approx \frac{1}{{N}_{c}} {\sum }_{i = 1}^{N} {𝕀}_{{y}_{i} = c} \cdot {f}_{θ} ( {x}_{i} ) [ c ] & [ Equation 5 ] \\ {𝔼}_{x \sim {p}_{u} ( x )} [ {e}^{{f}_{θ} ( x ) [ c ]} ] = {𝔼}_{( x , y ) \sim {p}_{s} ( x , y )} [ \frac{{p}_{u} ( y )}{{p}_{s} ( y )} {e}^{{f}_{θ} ( x ) [ c ]} ] \approx \frac{1}{N} {\sum }_{i = 1}^{N} \frac{{p}_{u} ( {y}_{i} )}{{p}_{s} ( {y}_{i} )} {e}^{{f}_{θ} ( {x}_{i} ) [ c ]} & [ Equation 6 ]\end{matrix}$$

In Equations 5 and 6, xᵢ and yᵢ denote an i-th sample and label, respectively. Also, N denotes the total number of samples, and N_{c} denotes the number of samples for class c.

In Equation 5, for the sample-label pair (x, y)˜pₛ(x, y), importance sampling can be used to approximate the expectation with respect to pᵤ(x) by using samples from pₛ(x), which is represented by Equation 7 below.

$$\frac{{p}_{u} ( x )}{{p}_{s} ( x )} = \frac{{Σ}_{c} {p}_{u} ( x \vert c ) {p}_{u} ( c )}{{Σ}_{c} {p}_{s} ( x \vert c ) {p}_{s} ( c )} = \frac{{p}_{u} ( y )}{{p}_{s} ( y )} \qquad [ Equation 7 ]$$

In Equation 7, it is assumed that pₛ(x|c)=0 for c≠y.

Meanwhile, the method may train the classification model by using information indicating regularization with respect to the label distribution of the source data.

In various embodiments, the method may calculate, by using Equations 8 and 9, a novel loss ( [symbol] _{LADER}) that regularizes the logits to approach Equation 2 by applying Equations 5 and 6 to Equation 4.

$$\begin{matrix} {ℒ}_{LADER} = {\sum }_{c ∈ 𝕊} {α}_{c} \cdot {ℒ}_{{LADER}_{c}} & [ Equation 8 ] \\ {ℒ}_{{LADER}_{c}} = - \frac{1}{{N}_{c}} {\sum }_{i = 1}^{N} {𝕀}_{{y}_{i} = c} \cdot {f}_{θ} ( {x}_{i} ) [ c ] + log ( \frac{1}{N} {\sum }_{i = 1}^{N} \frac{{p}_{u} ( {y}_{i} )}{{p}_{s} ( {y}_{i} )} {e}^{{f}_{θ} ( {x}_{i} ) [ c ]} ) + λ {( log ( \frac{1}{N} {\sum }_{i = 1}^{N} \frac{{p}_{u} ( {y}_{i} )}{{p}_{s} ( {y}_{i} )} {e}^{{f}_{θ} ( {x}_{i} ) [ c ]} ) )}^{2} & [ Equation 9 ]\end{matrix}$$

Equations 8 and 9 are defined for a single batch of sample-label pairs ((xᵢ=yᵢ)) with i=1, . . . , N. Also, in Equations 8 and 9, λ, α₁, . . . α_{c} denotes nonnegative hyperparameters, and C denotes the total number of classes. Furthermore, N_{c} denotes the number of samples of class c, and [symbol] denotes the set of classes existing inside the batch.

Meanwhile, it may be preferable to regularize major classes more strongly than minor classes to improve the performance of the classification model. Thus, the method in accordance with certain embodiments of the invention may apply a weight (e.g., α_{c}=pₛ(y=c)) for regularization of class c and [symbol] _{LADER}_{_{c}} of Equation 8, where the weights may be based on a size of each class.

In operation 420, the method generates a second output value by applying, to the first output value, information indicating a label distribution of target data.

For example, the method may apply, to the first output value, the information indicating the label distribution of the target data by performing a multiplication operation. The second output value generated by the method by applying, to the first output value, the information indicating the label distribution of the target data may be represented by Equation 10 below.

$$\begin{matrix}{p}_{t} ( y \vert x ; θ ) = \frac{{p}_{t} ( y ) {p}_{t} ( x \vert y ; θ )}{{\sum }_{c} {p}_{t} ( c ) {p}_{t} ( x \vert c ; θ )} \\ = \frac{{p}_{t} ( y ) {p}_{u} ( x \vert y ; θ )}{{\sum }_{c} {p}_{t} ( c ) {p}_{u} ( x \vert c ; θ )} \\ = \frac{{p}_{t} ( y ) \cdot {e}^{{f}_{θ} ( x ) [ y ]}}{{\sum }_{c} {p}_{t} ( c ) \cdot {e}^{{f}_{θ} ( x ) [ c ]}}\end{matrix} \qquad [ Equation 10 ]$$

In Equation 10, x denotes target data and y denotes a class (label). In addition, pₜ(y|x; θ) is the second output value, and denotes a probability of input data x, when input, being classified as class (label) y by a classification model θ.

In other words, the method may generate the second output value represented by Equation 10 by applying, to the first output value (f_{θ}(x)[y]) generated in operation 410, the information (pₜ(y)) indicating the label distribution of the target data.

In operation 430, the method classifies the target data as at least one class by using the second output value.

For example, the method may generate output data indicating that the target data is classified as the at least one class, by using Equation 10. Here, for the output data, a final loss function based on cross-entropy may be defined as in Equation 11 below.

[symbol]

_{LADE}(f_{θ}(x),y)= [symbol] _{LADE-CE}(f_{θ}(x),y)+α· [symbol] _{LADER}(f_{θ}(x),y) [Equation 11]

In Equation 11, [symbol] _{LADE}(f_{θ}(x),y) denotes a final loss function, and a denotes a nonnegative hyperparameter that determines the regularization strength of [symbol] _{LADER}. Also, in Equation 11, [symbol] _{LADE-CE}(x),y) may be calculated by Equation 12 below.

$$\begin{matrix}{ℒ}_{LADE - CE} ( {f}_{θ} ( x ) , y ) = - log ( {p}_{s} ( y \vert x ; θ ) ) \\ = - log ( \frac{{p}_{s} ( y ) \cdot {e}^{{f}_{θ} ( x ) [ y ]}}{{\sum }_{c} {p}_{s} ( c ) \cdot {e}^{{f}_{θ} ( x ) [ c ]}} )\end{matrix} \qquad [ Equation 12 ]$$

Meanwhile, the cross-entropy loss ( [symbol] _{CE}(f_{θ}(x),y)) can be represented by Equation 13 below.

$${ℒ}_{C E} ( {f}_{θ} ( x ) , y ) = - log ( p ( y \vert x ; θ ) ) , where \\ p ( y \vert x ; θ ) = \frac{{e}^{{f}_{θ} ( x ) [ y ]}}{{Σ}_{c} {e}^{{f}_{θ} ( x ) [ c ]}} \qquad [ Equation 13 ]$$

The method may derive Equation 12 based on Equation 13. The processor may calculate the final loss function ( [symbol] _{LADE}(f_{θ}(x),y)) based on [symbol] _{LADE-CE}(f_{θ}(x),y).

FIG. 5 is a configuration diagram illustrating an example of a data classification device 500, according to an embodiment.

The data classification device 500 illustrated in FIG. 5 can perform the method of classifying data described above with reference to FIG. 4. Therefore, although omitted below, it will be easily understood by one of skill in the art that the descriptions of the method of classifying data provided above with reference to FIG. 4 may be equally applied to the data classification device 500.

The data classification device 500 includes a memory 510 and the processor 520.

The memory 510 is operatively connected to the processor 520 and stores at least one program for the processor 520 to operate. In addition, the memory 510 stores all data related to the descriptions provided above with reference to FIGS. 1 to 4, such as training data, input data, output data, and information about classes.

For example, the memory 510 may temporarily or permanently store data processed by the processor 520. The memory 510 may include, but is not limited to, magnetic storage media or flash storage media. The memory 510 may include an internal memory and/or an external memory, and may include a volatile memory such as a dynamic random-access memory (DRAM), a static random-access memory (SRAM), or a synchronous DRAM (SDRAM), a nonvolatile memory such as a one-time programmable read-only memory (OTPROM), a programmable read-only memory (PROM), an erasable programmable read-only memory (EPROM), an electrically erasable programmable read-only memory (EEPROM), a mask read-only memory (ROM), a flash ROM, a NAND flash memory, or a NOR flash memory, a flash drive such as a solid-state drive (SSD), a compact flash (CF) card, a Secure Digital (SD) card, a Micro-SD card, a Mini-SD card, an eXtreme Digital (XD) card, or a memory stick, or a storage device such as a hard disk drive (HDD).

The processor 520 performs the method of classifying data described above with reference to FIGS. 1 to 4, according to a program stored in the memory 510.

The processor 520 trains a classification model for classifying input data into at least one class, such that a first output value is generated according to a second equation in which a component corresponding to a label distribution of source data is disentangled in a first equation corresponding to the classification model. Here, the first equation corresponds to Bayes' rule that represents the probability of input data being classified as each of at least one class.

For example, the processor 520 trains the classification model by using at least one approximation formula related to the second equation and information indicating the label distribution of the source data. Here, the at least one approximation formula can include a regularized DV representation and/or a Monte Carlo approximation formula.

In addition, the processor 520 can train the classification model using information indicating regularization with respect to the label distribution of the source data.

The processor 520 can generate a second output value by applying, to the first output value, information indicating a label distribution of target data. For example, the processor 520 may apply, to the first output value, the information indicating the label distribution of the target data by performing a multiplication operation.

Then, the processor 520 classifies the target data as at least one class by using the second output value.

For example, the processor 520 may refer to a hardware-embedded data processing device having a physically structured circuitry to perform functions represented by code or instructions included in a program. Here, an example of the hardware-embedded data processing device may include, but is not limited to, a processing device, such as a microprocessor, a central processing unit (CPU), a processor core, a multiprocessor, an application-specific integrated circuit (ASIC), and a field-programmable gate array (FPGA).

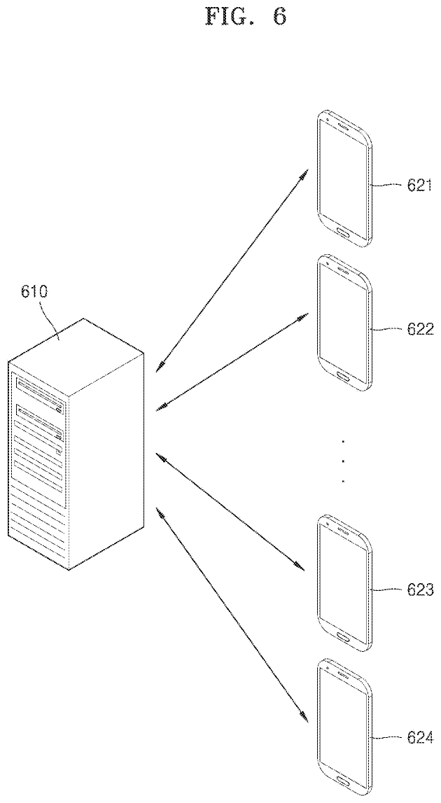

FIG. 6 is a diagram for describing an example in which a second output value is utilized, according to an embodiment.

FIG. 6 illustrates a network configuration including a server 610 and a plurality of terminals 621 to 624, according to an embodiment.

The server 610 may be a mediation device that connects the plurality of terminals 621 to 624 to each other. The server 610 may provide a mediation service for the plurality of terminals 621 to 624 to transmit and receive data to and from each other. The server 610 and the plurality of terminals 621 to 624 may be connected to each other through a communication network. The server 610 may transmit or receive data to or from the plurality of terminals 621 to 624 through the communication network.

Here, the communication network may be implemented as one of a wired communication network, a wireless communication network, and a complex communication network. For example, the communication network may include a mobile communication network such as 3G, Long-Term Evolution (LTE), LTE-A and 5G. Also, the communication network may include a wired or wireless communication network such as Wi-Fi, universal mobile telecommunications system (UMTS)/general packet radio service (GPRS), or Ethernet.

The communication network may include a short-range communication network such as magnetic secure transmission (MST), radio frequency identification (RFID), near-field communication (NFC), ZigBee, Z-Wave, Bluetooth, Bluetooth Low Energy (BLE), or infrared (IR) communication. The communication network may include a local area network (LAN), a metropolitan area network (MAN), or a wide area network (WAN).

Each of the plurality of terminals 621 to 624 may be implemented as one of a desktop computer, a laptop computer, a smart phone, a smart tablet, a smart watch, a mobile terminal, a digital camera, a wearable device, and a portable electronic device. Also, the plurality of terminals 621 to 624 may execute a program or an application.

For example, the plurality of terminals 621 to 624 may execute an application capable of receiving a mediation service. Here, the mediation service enables users of the plurality of terminals 621 to 624 to perform a video call and/or a voice call with each other.

In order to provide the mediation service, the server 610 may perform various classification tasks. For example, the server 610 may classify the users into predefined classes based on information provided from the users of the plurality of terminals 621 to 624. In particular, when the server 610 has received, from individuals subscribed to the mediation service (i.e., the users of the plurality of terminals 621 to 624), their facial images, the server 610 may classify the facial images into predefined classes for various purposes. For example, the predefined classes may be set based on genders or ages.

Here, the second output value generated according to the method described above with reference to FIG. 4 can be stored in the server 610, and the server 610 may accurately classify the facial images into the predefined classes.

According to the above descriptions, a classification model capable of accurately classifying input data into predefined classes regardless of the distribution of the input data may be generated.

Meanwhile, the above-described method may be written as a computer-executable program, and may be implemented in a general-purpose digital computer that executes the program by using a computer-readable recording medium. In addition, the structure of the data used in the above-described method may be recorded in a computer-readable recording medium through various means. Examples of the computer-readable recording medium include magnetic storage media (e.g., ROMs, RAMs, universal serial bus (USB), floppy disks, hard disks, etc.), and optical recording media (e.g., compact disc-ROMs (CD-ROMs), digital versatile disks (DVDs), etc.).

It will be understood by one of skill in the art that the disclosure may be implemented in a modified form without departing from the intrinsic characteristics of the descriptions provided above. The methods disclosed herein are to be considered in a descriptive sense only, and not for purposes of limitation, and the scope of the disclosure is defined not by the above descriptions, but by the claims and their equivalents, and all variations within the scope of the claims and their equivalents are to be construed as being included in the disclosure.

What is claimed is:

1. A method of classifying data, the method comprising:
training a classification model for classifying input data into at least one class, such that a first output value is generated according to a second equation in which a component corresponding to a label distribution of source data is disentangled in a first equation corresponding to the classification model;
generating a second output value by applying, to the first output value, information indicating a label distribution of target data; and
classifying the target data into the at least one class by using the second output value.

2. The method of claim 1, wherein the first equation comprises an equation corresponding to a Bayes' rule representing a probability of the input data being classified as each of the at least one class.

3. The method of claim 1, wherein, in the generating of the second output value, the information indicating the label distribution of the target data is applied to the first output value by performing a multiplication operation.

4. The method of claim 1, wherein, in the training of the classification model, the classification model is trained by using at least one approximation formula with respect to the second equation and information indicating the label distribution of the source data.

5. The method of claim 4, wherein the at least one approximation formula comprises at least one selected from the group consisting of a regularized Donsker-Varadhan (DV) representation and a Monte Carlo approximation formula.

6. The method of claim 1, wherein, in the training of the classification model, the classification model is trained by using information indicating regularization with respect to the label distribution of the source data.

7. The method of claim 1, wherein training the classification model such that a first output value is generated according to a second equation in which a component corresponding to a label distribution of source data is disentangled in a first equation corresponding to the classification model comprises training the classification model using only the distribution of the samples x (pₛ(x)) from the training data and the conditional distribution of samples x given the labels y(pₛ(x|y)).

8. A computer-readable recording medium having recorded thereon a program for executing the method of claim 1 on a computer.

9. A device for classifying data, the device comprising:
a memory storing at least one program; and
a processor configured to execute the at least one program to
train a classification model for classifying input data into at least one class, such that a first output value is generated according to a second equation in which a component corresponding to a label distribution of source data is disentangled in a first equation corresponding to the classification model,
generate a second output value by applying, to the first output value, information indicating a label distribution of target data, and
classify the target data into the at least one class by using the second output value.

10. The device of claim 9, wherein
the first equation comprises an equation corresponding to a Bayes' rule representing a probability of the input data being classified as each of the at least one class.

11. The device of claim 9, wherein
the processor is further configured to execute the at least one program to apply, to the first output value, the information indicating the label distribution of the target data by performing a multiplication operation.

12. The device of claim 9, wherein
the processor is further configured to execute the at least one program to train the classification model by using at least one approximation formula with respect to the second equation and information indicating the label distribution of the source data.

13. The device of claim 12, wherein
the at least one approximation formula comprises a regularized Donsker-Varadhan (DV) representation and a Monte Carlo approximation formula.

14. The device of claim 9, wherein
the processor is further configured to execute the at least one program to train the classification model by using information indicating regularization with respect to the label distribution of the source data.

15. The device of claim 9, wherein the processor is further configured to execute the at least one program to train the classification model such that a first output value is generated according to a second equation in which a component corresponding to a label distribution of source data is disentangled in a first equation corresponding to the classification model by training the classification model using only the distribution of the samples x (pₛ(x)) from the training data and the conditional distribution of samples x given the labels y (pₛ(x|y)).
